(19) United States
(12) Patent Application Publication
(10) Pub. No.: US 2018/0245184 A1
(43) Pub. Date: Aug. 30, 2018

(54) SLIDING ELEMENT COMPOSED OF A COPPER ALLOY

(71) Applicant: WIELAND-WERKE AG, Ulm (DE)

(72) Inventors: Hans-Achim KUHN, Illertissen (DE); Joerg SEEGER, Ulm (DE)

(21) Appl. No.: 15/875,061

(22) Filed: Jan. 19, 2018

(30) Foreign Application Priority Data
Feb. 25, 2017 (DE) 10 2017 001 846.4

(51) Int. Cl. C22C 9/06; F16C 17/02; F16C 33/12

(52) U.S. Cl. CPC C22C 9/06; F16C 2204/10; F16C 33/121; F16C 17/02

(57) ABSTRACT

The invention relates to a sliding element composed of a copper alloy which contains the following constituents (in % by weight):
from 2.0 to 3.0% of Ni,
from 0.45 to 1.0% of Si,
up to 1.5% of Ti and/or Cr, where the sum of the Ni content [Ni] and the Ti content [Ti]: [Ni]+[Ti] is ≥0.2%,
optionally from 0.05 to 1.5% of Co,
optionally in each case from 0.05 to 0.1% of Mg, Al, Fe,
optionally from 0.01 to 0.1% of Pb,
optionally from 0.002 to 0.01% of P,
a balance of Cu and unavoidable impurities,
   wherein the ratio of the sum of the Ni content [Ni], Ti content [Ti] and Cr content [Cr] to the Si content [Si] is such that:

4.3≤([Ni]+[Ti]+[Cr])/[Si]≤6.5.

### CROSS-REFERENCE TO RELATED APPLICATIONS

This claims priority from German Patent Application No. 10 2017 001 846.4, filed Feb. 25, 2017, the disclosure of which is hereby incorporated by reference in its entirety into this application.

### FIELD OF THE INVENTION

The invention relates to a sliding element composed of a copper alloy as per the preamble of Claim 1.

Sliding elements composed of copper alloys are used, for example, in internal combustion engines in bearings of the connecting rod or of the crankshaft. The technical requirements which the material of the sliding elements has to meet are becoming greater with the development of modern engines. Legal requirements additionally demand a reduction in the proportion of lead in the material to a minimum. At the same time, the pressure to reduce the costs of the sliding elements is increasing.

A known copper-zinc alloy for sliding elements is CuZn31Si1. Up to 0.8% by weight of lead can be added to the alloy in order to improve the cutting machinability of the material. The high proportion of copper in this alloy makes the sliding element expensive. Furthermore, the percentage contact area of the wear-resistant microstructural constituents in this alloy is too low to withstand in future the stresses prevailing in modern engines.

### BACKGROUND OF THE INVENTION

A copper alloy which has excellent strength and shapability for use in electric and electronic components is known from the document EP 2 128 282 A1. The copper alloy comprises from 1.5% by weight to 4.5% by weight of nickel (Ni) and from 0.3% by weight to 1.0% by weight of silicon (Si). It optionally further comprises one or both of from 0.01% by weight to 1.3% by weight of tin (Sn) and from 0.005% by weight to 0.2% by weight of magnesium (Mg), from 0.01% by weight to 5% by weight of zinc (Zn), one or both of from 0.01% by weight to 0.5% by weight of manganese (Mn) and from 0.001% by weight to 0.1% by weight of chromium (Cr), a total of 0.1% by weight or less of at least one constituent selected from the first group of elements consisting of B, C, P, S, Ca, V, Ga, Ge, Nb, Mo, Hf, Ta, Bi and Pb, in each case in an amount of from 0.0001% by weight to 0.1% by weight, and a total of 1% by weight or less of at least one constituent selected from the second group of elements consisting of Be, Al, Ti, Fe, Co, Zr, Ag, Cd, In, Sb, Te and Au, in each case in an amount of from 0.001% by weight to 1% by weight, where the total amount of the first and second group of elements is 1% by weight or less, with the balance being copper and unavoidable impurities.

Furthermore, the document EP 2 463 393 A1 discloses a copper alloy containing Ni: 1.5% by weight to 3.6% by weight and Si: 0.3% by weight to 1.0% by weight, with the balance consisting of copper and unavoidable impurities. In addition, the copper alloy can optionally contain one or more elements selected from the group consisting of Fe, Mn, Mg, Co, Ti, Cr and Zr in a total amount of from 0.01% by weight to 3.0% by weight.

The copper alloy has crystal grains having an average crystal grain size of from 5 μm to 30 μm. The ratio by area of the crystal grains which have not less than twice the average crystal grain size is not less than 3%; the ratio by area of the crystal grains having cubic orientation to the region of the crystal grains having crystal grain sizes of not less than twice the average crystal grain size is not less than 50%.

In addition, the document WO 2009/082695 A1 discloses an alloy which is based on copper and has an improved combination of yield point and electrical conductivity for electronic applications. The coper alloy consists essentially of from 1.0% by weight to 6.0% by weight of Ni, up to about 3.0% by weight of Co, from 0.5% by weight to 2.0% by weight of Si, from 0.01% by weight to 0.5% by weight of Mg, up to 1.0% by weight of Cr, up to 1.0% by weight of Sn and up to 1.0% by weight of Mn, with the balance being copper and impurities. The alloy is treated so that it has a yield point of at least about 945 MPa and an electrical conductivity of at least about 25% of IACS.

### SUMMARY OF THE INVENTION

It is an object of the invention to provide a sliding element resistant to wear by friction against steel and additionally further develop a copper alloy.

The invention is defined by the features of claim 1. The further dependent claims relate to advantageous embodiments and further developments of the invention.

The invention encompasses a sliding element composed of a copper alloy which contains the following constituents (in % by weight):

from 2.0 to 3.0% of Ni,

from 0.45 to 1.0% of Si,

up to 1.5% of Ti and/or Cr, where the sum of the Ni content [Ni] and the Ti content [Ti]: [Ni]+[Ti] is ≥0.2%,

optionally from 0.05 to 1.5% of Co,

optionally in each case from 0.05 to 0.1% of Mg, Al, Fe,

optionally from 0.01 to 0.8% of Pb,

optionally from 0.002 to 0.01% of P,

a balance of Cu and unavoidable impurities,

characterized in that the ratio of the sum of the Ni content [Ni], Ti content [Ti] and Cr content [Cr] to the Si content [Si] is such that:

4.3≤([Ni]+[Ti]+[Cr])/[Si]≤6.5.

The copper alloy preferably has a Ti and/or Cr content of at least 0.2% by weight.

The alloy of the sliding element of the invention contains hard phases which are embedded in the matrix of the alloy. Such hard phases produce a substantial percentage contact area in a friction pairing. It is also possible for a plurality of fractions of hard phases which differ in terms of their particle size to be formed.

The at least one fraction of the above-disclosed precipitates provides, as a result of the hard phases formed, a percentage contact area of up to about 3% of the proportion by area of a friction pairing. Proportions by area of up to 5% provide still particularly preferred percentage contact areas. A significant reduction in the coefficients of friction or the coefficients of sliding friction is also brought about thereby.

The optionally introduced elements magnesium, aluminum and iron further improve the mechanical properties and the resistance to corrosive influences.

The lead content of the alloy can in principle be up to 0.8% by weight. If legal requirements allow, up to 0.25% by weight of lead can be added if necessary to the alloy as chip breaker. The lead content is preferably not more than 0.1% by weight. However, the alloy particularly preferably has a lead content which is in the range of unavoidable impurities. The function of a sliding element according to the invention is not impaired by the absence of lead.

Up to 0.08% by weight of phosphorus can optionally also be added to the sliding element alloy. Phosphorus serves to deoxidize the melt and together with nickel forms nickel phosphides which likewise contribute to the wear resistance.

A particular form of sliding elements are sliding bearing bushes. Among sliding bearing bushes, a distinction is made between rolled and turned bushes on account of the different production methods.

Rolled bushes are produced from a strip-like semifinished part composed of the copper alloy of the invention by shaping an appropriately dimensioned section of strip to form a hollow cylinder and joining the abutting strip edges. Preference is given to using the material from strip and plate casting. Here, a relatively thin strip is cast as casting shape in the case of strip casting. Casts slabs are, in contrast to the thin cast strip, hot formed. The cooling from the hot forming stage can itself lead to formation of the Cr-, Ti- and Si-containing particles. In order to influence the following process steps of cold forming and heat treatment in respect of final strength, cooling from the hot forming stage is carried out quickly.

Turned bushes are produced by cutting machining from a rod- or tube-shaped semifinished part composed of the copper alloy of the invention. To produce the semifinished part, a cylindrical cast shape is cast, and from this a pressed tube or a rod is pressed by means of a hot pressing operation. The semifinished part from which the sliding bearing bush is produced is obtained from the respective pressing product by means of a sequence of drawing operations. For this production route, the alloy used has to be able to be readily hot and cold formed. Furthermore, the alloy has to be able to be subjected to cutting machining.

A particular advantage of a sliding element made of the copper alloy of the invention is a low coefficient of friction compared to alternative solutions used on the market. In addition, the sliding element of the invention displays good resistance to stress relaxation and an associated stable settling behavior, for example in the case of bearing bushes [H.-A. Kuhn, M. Knab, R. Koch: Thermal Stability of Lead-free Wrought Cu-Based Alloys for Automotive Bushings, World of Metallurgy—ERZMETALL 60 (2007), 199]. A likewise high thermal conductance of the sliding element of the invention results in a low tendency for thermally induced stresses to occur in the material. Overall, the solution according to the invention is a sliding element composed of a copper alloy in the form of a wear-resistant ductile material having a high thermal conductivity, suitability for good settling behavior and an improved coefficient of friction with oil lubrication, in particular together with friction partners made of steel. Overall, the tribological system on which the sliding bearing is based and which has precipitates of hard phases has further advantageous properties in that it allows dirt particles to be embedded on the tribological surface. The wear-resistant precipitates considerably increase the percentage contact area of the tribological surface.

The ratio ([Ni]+[Ti]+[Cr])/[Si] can advantageously be such that

5.1≤([Ni]+[Ti]+[Cr])/[Si]≤6.2. At element ratios in the range indicated, dispersions of hard phases are formed in the matrix of the alloy and the percentage contact area of these in a friction pairing leads to a particularly low tendency for wear to occur. The number and size of particles is in a particularly preferred range here.

In a preferred embodiment of the invention, from 2.3 to 2.7% of Ni and/or from 0.45 to 0.65% of Si can be present. The selected range of the elements nickel and silicon represents, together with the further elements titanium and/or chromium, a particularly suitable selection in respect of the particle size and distribution.

In a preferred embodiment of the invention, at least one fraction of precipitates where the precipitates having a volume-equivalent sphere diameter of at least 1.0 μm have a density of from 5000 to 20 000 particles per mm² is present. The precipitates can be round or else ellipsoidally extended particles having a stoichiometric composition or be nonstoichiometric precipitates of the systems Cr—Ni—Si, TiSi or Cr—Si. Furthermore, the precipitates can be round or else ellipsoidally extended particles having a stoichiometric composition or be nonstoichiometric precipitates of the system Ti—Ni—Si. The Ni content can here advantageously be greater than or equal to the Ti content. Nonrounded particles having a rather jagged or angular appearance can likewise be embedded in the matrix of the alloy.

In this embodiment, the alloy of the sliding element of the invention can also contain a plurality of populations of precipitates. For example, it can comprise a first population having relatively small precipitates and at least one second population having relatively large precipitates. The large precipitates act as a particularly wear-resistant percentage contact area. The proportion by volume thereof in the microstructure can be comparatively small and be in the range from 1 to 2%. Owing to the low density of the second population, relatively large interstices remain between these precipitates. These interstices are stabilized by the first population having smaller precipitates. Due to the first population stabilizing the matrix in the interstices, these precipitates prevent the large precipitates of the second population from breaking out.

The precipitates are a hard phase which is embedded in an alloy matrix and can produce a significant percentage contact area in a friction pairing.

In a further advantageous embodiment, at least one fraction of precipitates where the precipitates having a volume-equivalent sphere diameter of at least 1.0 μm have a density of from 10 000 to 20 000 particles per mm² can be present. The proportion of hard phase which determines the positive sliding properties is ensured by a high particle density.

It can be advantageous for at least one fraction of precipitates where the precipitates having a volume-equivalent sphere diameter of at least 1.0 μm and not more than 3.0 μm have a density of from 10 000 to 18 000 particles per mm² to be present. Here, the critical fraction of the precipitates is in the size range from 1.0 μm to 3.0 μm. Larger precipitates here occur rather scarcely.

In a preferred embodiment of the invention, the precipitates can be Cr-containing and/or Ti-containing silicides. The precipitates can be round or else ellipsoidally extended particles having the composition (Cr,Ni)₂Si, (Cr,Ni)₃Si, Cr₃Si or be nonstoichiometric precipitates of the systems Cr—Ni—Si or Cr—Si. Furthermore, the precipitates can be round or else ellipsoidally extended particles of the composition (Ti,Ni)₂Si, (Ti,Ni)₃Si, Ti₅Si₃ or be nonstoichiometric precipitates of the system Ti—Ni—Si. The Ni content can here advantageously be greater than or equal to the Ti content.

In a preferred embodiment of the invention, the Ti content and/or Cr content can be not more than 1.0% by weight. In a further advantageous embodiment, the Ti content and/or Cr content can be at least 0.45% by weight and not more than 0.95% by weight. As a result, the hard phases embedded in the alloy matrix produce a particularly advantageous percentage contact area in a friction pairing. In addition, this leads to good resistance to stress relaxation and an associated good settling behavior of the material. Thus, a sliding element comprising a copper alloy in the form of a wear-resistant ductile material having high thermal conductivity, a suitability for good settling behavior and an improved coefficient of friction in the case of oil lubrication is provided.

The electrical conductivity after a thermal treatment in the range from 300° C. to 600° C. can advantageously be at least 25 MS/m. In addition, the final thermal treatment can preferably be at a temperature in the range from 400° C. to 500° C. Here, the thermal treatment can be the last concluding thermal process step. The electrical conductivity is directly related to the thermal conductivity. The preferred mechanical properties are also finally set in the alloy by the abovementioned thermal treatment, for example for times of from 1 to 3 hours.

In a preferred embodiment of the invention, the ratio of the thermal expansion α in the temperature range from 20° C. to 300° C. to the thermal conductivity λ at room temperature, α/λ, can be from 0.09 to 0.20 μm/W. A thermal conductivity λ is also associated with a comparatively high electrical conductivity of up to 29.5 MS/m. This electrical conductivity is significantly above that of the Cr- and Ti-free comparative samples.

In a preferred embodiment of the invention, the hardness after a final thermal treatment in the range from 300° C. to 600° C. can be at least 150 HBW 2.5/62.5. More preferably the final thermal treatment can be at a temperature in the range from 400° C. to 500° C.

The invention will be illustrated with the aid of working examples.

Various samples of sliding element copper alloys were melted and cast profiles were cast. After milling off the casting skin, the thickness d of the samples was about 20 mm. A hot rolling process with rolling down to 8 mm was then carried out, associated with quenching by means of water. The samples were then rolled down to 2 mm by means of cold rolling. A final aging step was carried out at a temperature of from 300 to 600° C. for about 2 hours. Table 1 shows, by way of example, the composition of individual samples which were aged at 450° C.

TABLE 1
Composition of alloy variants [% by weight]:

| Sample | | | | | | | | |
|---|---|---|---|---|---|---|---|---|
| No. | Cu | Ni | Si | Ti | Cr | (Ni + Ti + Cr)/Si | Ni/Si | Suitability |
| 1 | Balance | 2.35 | 0.61 | 0.83 | — | 5.21 | 3.85 | Excellent |
| 2 | Balance | 2.4 | 0.6 | 0.5 | — | 4.83 | 4.00 | Excellent |
| 3 | Balance | 2.4 | 0.6 | 0.2 | — | 4.33 | 4.00 | Good |
| 4 | Balance | 2.41 | 0.58 | — | 1.14 | 6.12 | 4.16 | Excellent |
| 5 | Balance | 2.4 | 0.6 | — | 0.7 | 5.16 | 4.00 | Excellent |
| 6 | Balance | 2.4 | 0.6 | — | 0.46 | 4.76 | 4.00 | Good |
| 7 | Balance | 2.4 | 0.6 | — | 0.22 | 4.36 | 4.00 | Good |
| 8 | Balance | 2.4 | 0.6 | 0.5 | 0.2 | 5.17 | 4.00 | Good |
| 9 | Balance | 2.4 | 0.6 | 0.2 | 0.46 | 5.10 | 4.00 | Good |
| 10 | Balance | 2.4 | 0.6 | 0.048 | — | 4.08 | 4.00 | Unsatisfactory! |
| 11 | Balance | 2.36 | 0.58 | — | — | 4.07 | 4.07 | Unsatisfactory! |

Samples No. 1 and 4 have particularly preferred properties for suitability for sliding bearings according to the invention.

Sliding elements, in particular bushes, are subjected to thermally induced stresses and distortions during operation in an engine. Such thermally induced distortions depend on the material-specific ratio of the average coefficient of thermal expansion α and the thermal conductivity λ. Owing to the comparatively low coefficient of thermal expansion α and the significantly higher thermal conductivity λ (figures in Table 2 relate to room temperature RT), the thermally induced distortions in bearing bushes, in particular in the case of the low-alloyed copper materials of samples 1 and 4 listed in Table 2, are advantageously low.

TABLE 2
Physical properties of samples No. 1 and 4 after final
heat treatment with further comparative samples:

| | | | Thermal | Coefficient of | |
|---|---|---|---|---|---|
| | | Electrical | conductivity | thermal expansion | α/λ |
| | Hardness | conductivity | λ (W/mK) | α × 10⁶ K | (μm/W) |
| Sample No./alloy | HB | (MS/m) | at RT | (20° C. to 300° C.) | at RT |
| 1 | 159 | 21.1 | 140 | 17.5 | 0.125 |
| 4 | 198 | 25.4 | 160 | 18 | 0.113 |
| CuNi6Sn6 | 240 | 8.5 | 55 | 18 | 0.327 |
| CuZn31Mn2Si1Al1NiFe | 190 | 11.5 | 75 | 19.6 | 0.261 |
| CuZn37Mn3Al2PbSi | 165 | 7.8 | 63 | 20.4 | 0.324 |

Since, for example, sliding bearing bushes are usually inserted in higher strength connecting rod material, thermally induced distortions would cause additional mechanical stresses. Lower thermally induced distortions are consequently also advantageous for resistance to undesirable stress relaxation. This also results in an advantageous temperature- and time-dependent settling behavior of sliding bearings, in particular of bushes.

The wear resistance of a sliding element according to the invention is determined with the aid of suitable experiments and compared with the wear resistance of sliding elements composed of known materials. Wear tests show, particularly in the case of the samples 1 and 4 indicated in Table 2, no pronounced running-in phases.

### BRIEF DESCRIPTION OF THE DRAWINGS

FIG. 1 is Graph 1 which contains Coefficients of friction μ (samples No. 1 and 4 with comparative samples); and

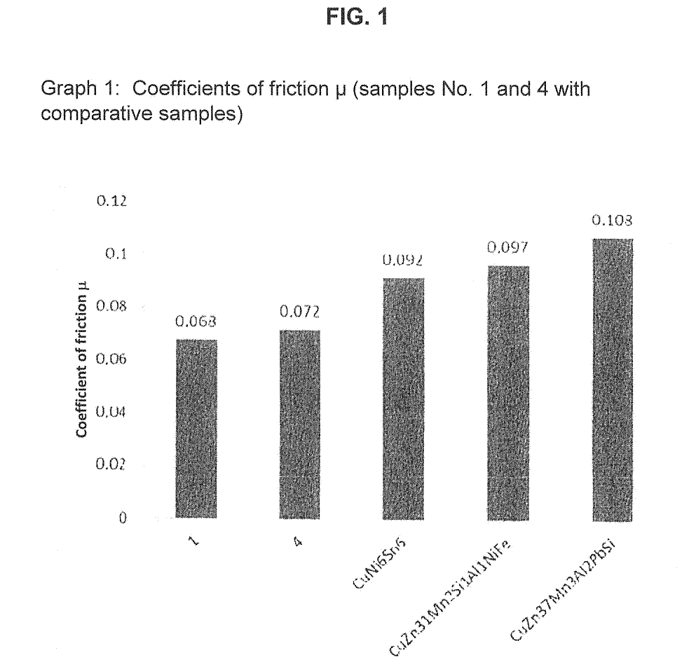

FIG. 2 is Graph 2 which contains Wear (samples No. 1 and 4 with comparative samples).

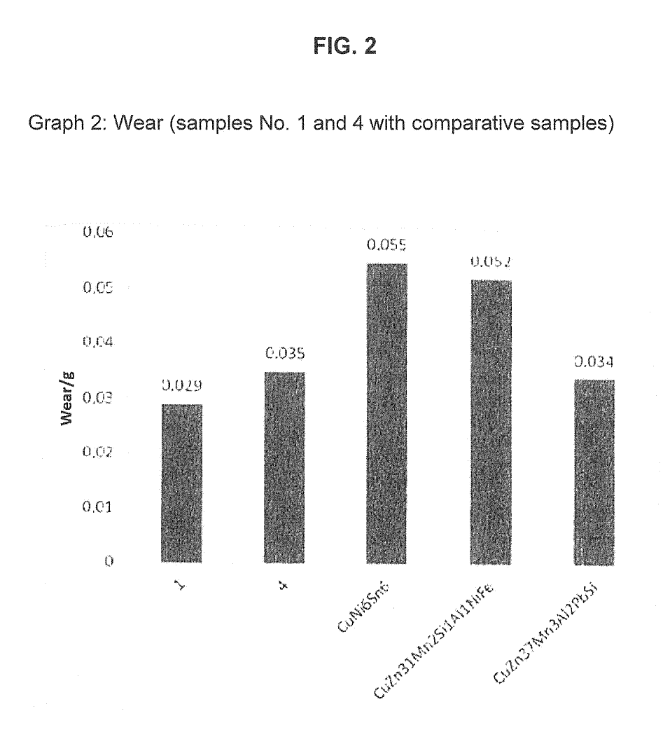

The coefficients of friction μ in graph 1 and the degrees of wear in graph 2 for the samples 1 and 4 and also samples of comparative alloys were determined by means of a tribometer during long-term running. The friction pairing consists of a flat plate of the alloy and annular segments composed of the steel 100Cr6. The steel rotates at a sliding speed of 1 m/sec on the sheet of the copper material. The friction partners are lubricated with a commercial engine oil at a temperature of 120° C. After a running-in phase in two stages, a constant load of 600 N is applied for 5.5 h. Here, the force applied per unit area is 9 N/mm².

Compared to copper-based bearing materials being used today, the alloys of the invention display a lower average coefficient of friction. Both working examples 1 and 4 wear significantly less than the tin-nickel bronze and a tried-and-tested iron-containing specialty brass with mixed silicides.

1. Sliding element composed of a copper alloy which contains the following constituents (in % by weight):
from 2.0 to 3.0% of Ni,
from 0.45 to 1.0% of Si,
up to 1.5% of Ti and/or Cr, where the sum of the Ni content [Ni] and the Ti content [Ti]: [Ni]+[Ti] is ≥0.2%,
optionally from 0.05 to 1.5% of Co,
optionally in each case from 0.05 to 0.1% of Mg, Al, Fe,
optionally from 0.01 to 0.1% of Pb,
optionally from 0.002 to 0.01% of P,
a balance of Cu and unavoidable impurities, characterized in that the ratio of the sum of the Ni content [Ni], Ti content [Ti] and Cr content [Cr] to the Si content [Si] is such that:
4.3≤([Ni]+[Ti]+[Cr])/[Si]≤6.5.

2. Sliding element according to claim 1, characterized in that the ratio is such that:
5.1≤([Ni]+[Ti]+[Cr])/[Si]≤6.2.

3. Sliding element according to claim 1, characterized by
from 2.3 to 2.7% of Ni and/or
from 0.45 to 0.65% of Si.

4. Sliding element according to claim 1, characterized in that at least one fraction of precipitates where the precipitates having a volume-equivalent sphere diameter of at least 1.0 μm have a density of from 5000 to 20 000 particles per mm² is present.

5. Sliding element according to claim 4, characterized in that at least one fraction of precipitates where the precipitates having a volume-equivalent sphere diameter of at least 1.0 μm have a density of from 10 000 to 20 000 particles per mm² is present.

6. Sliding element according to claim 5, characterized in that at least one fraction of precipitates where the precipitates having a volume-equivalent sphere diameter of at least 1.0 μm and not more than 3.0 μm have a density of from 10 000 to 18 000 particles per mm² is present.

7. Sliding element according to claim 4, characterized in that the precipitates are Cr-containing and/or Ti-containing silicides.

8. Sliding element according to claim 1, characterized in that the Ti content and/or Cr content is not more than 1.0% by weight.

9. Sliding element according to claim 8, characterized in that the Ti content and/or Cr content is at least 0.45% by weight and not more than 0.95% by weight.

10. Sliding element according to claim 1, characterized in that the electrical conductivity after a thermal treatment in the range from 300° C. to 600° C. is at least 25 MS/m.

11. Sliding element according to claim 1, characterized in that the ratio of the coefficient of thermal expansion α in the temperature range from 20° C. to 300° C. to the thermal conductivity λ at room temperature, α/λ, is from 0.09 to 0.20 μm/W.

12. Sliding element according to claim 1, characterized in that the hardness after a final thermal treatment in the range from 300° C. to 600° C. is at least 150 HBW 2.5/62.5.
